(19) United States
(12) Patent Application Publication
(10) Pub. No.: US 2022/0338491 A1
(43) Pub. Date: Oct. 27, 2022

(54) DEVICE FOR THREADING A SKEWER THROUGH AN ELASTIC SAUSAGE

(71) Applicant: Dongguan Dingzhong Automation Equipment Co., Ltd., Dongguan City (CN)

(72) Inventors: Changqing LI, Dongguan City (CN); Tuqing QIN, Dongguan City (CN)

(21) Appl. No.: 17/557,340

(22) Filed: Dec. 21, 2021

(30) Foreign Application Priority Data
Apr. 26, 2021 (CN) 202110454544.5

(51) Int. Cl. A22C 17/00; A23P 10/10

(52) U.S. Cl. CPC A22C 17/006; A23P 10/10

(57) ABSTRACT

A device for threading a skewer through an elastic sausage is provided, which includes a driving component, material placing templates, a pressing component, a push plate and a pressing bar. The driving component is connected with the pressing component. The pressing component is provided above the material placing templates. Pressing blocks which are transversely and appositionally arranged are provided in the pressing component. The pressing bar is provided above the pressing blocks. The push plate is provided on a side of the material placing templates and is connected with the driving component and the pressing bar.

### CROSS REFERENCE TO RELATED APPLICATION

This patent application claims the benefit and priority of Chinese Patent Application No. 202110454544.5 filed on Apr. 26, 2021, the disclosure of which is incorporated by reference herein in its entirety as part of the present application.

### TECHNICAL FIELD

The present disclosure relates to the field of barbecue food preparation, in particular to a device for threading a skewer through an elastic sausage.

### BACKGROUND ART

Barbecue refers to the process of roasting meat and meat products on charcoal or an electric heating device. Generally speaking, the barbecue is to roast food on fire and cook the food until the food is edible. In modern society, because human beings have invented a variety of ways to use fire, the barbecue method is gradually diversified. Among many barbecue food, elastic sausages are popular by people. However, it is troublesome to thread skewers through elastic sausages. Because elastic sausages have the fragility, even when the elastic sausages are manually threaded skewers, the elastic sausages are still easy to break. So, the production efficiency is low, and the production cost may be increased due to the operation of manually threading skewers and the easy breakage.

The existing machine for threading skewers (authorized publication No. CN 204579697U, and authorized publication date is Aug. 26, 2015) can thread the skewer through a hot dog or other an ordinary sausage. Although some steps in the manual processing can be omitted, this machine still causes the breakage or the extrusion deformation of the elastic sausages when threading the skewers through the elastic sausages.

### SUMMARY

In order to overcome the problems that the efficiency of manually threading skewers is low, and the elastic sausages are easily broken during production, the present disclosure aims to provide a technical scheme capable of solving the above problems.

A device for threading a skewer through an elastic sausage is provided, which includes a driving component, material placing templates, a pressing component, a push plate and a pressing bar, wherein the driving component is connected with the pressing component, the pressing component is provided above the material placing templates, a plurality of pressing blocks which are transversely and appositionally arranged are provided in the pressing component, the pressing bar is provided above the pressing blocks, and the push plate is provided on a side of the material placing templates, and is connected with the driving component and the pressing bar.

As one of the improvements of the above technical scheme, the pressing component comprises an upper limit plate, a lower limit plate and a plurality of guide rods, the pressing blocks are provided below the lower limit plate, the guide rods pass through the upper limit plate and the lower limit plate in sequence from top to bottom and are connected with the pressing blocks, each of return springs is sleeved on a corresponding one of the guide rods, an upper end of the return spring is connected with a top of the corresponding one of the guide rods, and a lower end of the return spring is connected with a top surface of the upper limit plate.

As one of the improvements of the above technical scheme, the pressing bar is provided between the upper limit plate and the lower limit plate, one end of the pressing bar is formed with a downward protruding working surface, two sides of an other end of the pressing bar are provided with a plurality of auxiliary pressing plates, an ear plate is installed on a bottom surface of the upper limit plate, an aligning rod provided along a length direction of the pressing bar is installed on the pressing bar, and the aligning rod is passed through the ear plate and is slidably fitted with the ear plate.

As one of the improvements of the above technical scheme, the lower limit plate is formed with a long opening and short openings; the short openings are provided at two sides of an end of the long opening, the long opening and the short openings are each provided with a plurality of clamping bases; a top surface of each of the plurality of clamping bases is provided with a bearing rotatably fitted with the clamping base; and a bottom surface of each of the clamping bases is connected with a corresponding one of the pressing blocks.

As one of the improvements of the above technical scheme, the plurality of clamping bases in the long opening are arranged in manner of a straight line, and the plurality of clamping bases in each of the short openings are obliquely arranged.

As one of the improvements of the above technical scheme, the working surface of the pressing bar is rollingly fitted with the bearing of each of the clamping bases in the long opening, the plurality of auxiliary pressing plates are arranged appositionally, inner ones of the auxiliary pressing plates are short, outer ones of the auxiliary pressing plates are long, ones, which are opposite to the auxiliary pressing plates, of the plurality of clamping bases in each of the short openings are staggered and arranged in sequence, and each of the auxiliary pressing plates is rollingly fitted with the bearing of a respective one of the plurality of clamping bases in a corresponding one of the short openings.

As one of the improvements of the above technical scheme, the working surface of the pressing bar is mutually matched with the bearing of each of the plurality of the clamping bases in the long opening, and the auxiliary pressing plates are independently matched with the bearing of each of the plurality of clamping bases in each of the short openings.

As one of the improvements of the above technical scheme, a support and a long plate are provided above the pressing component, the long plate is connected with the pressing component, a press-applying plate is connected with the long plate, the press-applying plate is provided above the long plate, slide rails are formed on the long plate, the push plate is installed on the slide rails and is slidably fitted with the slide rails, a plurality of slide bars provided vertically are installed on a top surface of the long plate, and the slide bars are passed through the support upwards and are slidably fitted with the support.

As one of the improvements of the above technical scheme, the driving component comprises a motor, a cam, a transmission rod and a lever, the motor is installed on the support, the cam is installed in front of the long plate and is coaxially connected with a rotating shaft of the motor, one end of the transmission rod is hinged with a side surface of the cam, an other end of the transmission rod is hinged with the push plate, one end of the lever is installed with a groove roller that is rotatably fitted with the lever, an inner wall of a groove of the groove roller is attached to an outer ring of the cam, the groove roller is rollingly fitted with the cam, an other end of the lever is placed on the press-applying plate, and a middle section of the lever is installed on the support and is rotatably fitted with the support.

As one of the improvements of the above technical scheme, a plurality of tooth holes are formed on the side surface of the cam, a detachable adjusting shaft is installed in one of the tooth holes, and the adjusting shaft is hinged with the transmission rod.

Compared with the prior art, the present disclosure has the following beneficial effects.

1. The cooperation of the pressing component, the pressing blocks and the pressing bar can ensure that the elastic sausages are not easily broken in the process of threading skewers, and the extrusion deformation does not occur, thereby improving the product qualification rate, reducing the waste products and decreasing the production cost.

2. The whole process of threading skewers is automatic, and there is no need to manually thread skewers, thereby improving the production efficiency.

3. A single motor is used to drive, thereby simplifying the driving mode, and improving the stability during operation.

4. Through adjusting different positions of the adjusting shaft in the tooth holes, which are on the side surface of the cam, the elastic sausages or bamboo skewers with different lengths may be matched.

Additional aspects and advantages of the present disclosure will be partially set forth in the following description. The additional aspects and advantages will be clear partially from the following description, or may be learned by practice of the present disclosure.

### BRIEF DESCRIPTION OF THE DRAWINGS

In order to explain the embodiments of the present disclosure or the technical scheme in the prior art more clearly, the drawings used in the embodiments or the description of the prior art will be briefly introduced hereinafter. Obviously, the drawings in the following description are only some embodiments of the present disclosure. For those skilled in the art, other drawings can be obtained according to these drawings without paying creative labor.

FIG. 1 is a schematic diagram of a structure according to an embodiment of the present disclosure.

FIG. 2 is another schematic diagram of the structure according to an embodiment of the present disclosure.

FIG. 3 is an enlarged view of a portion A in FIG. 1.

FIG. 4 is a schematic structural diagram of a lower limit plate according to an embodiment of the present disclosure.

FIG. 5 is a schematic structural diagram of a pressing block according to an embodiment of the present disclosure.

FIG. 6 is a schematic structural diagram of a pressing bar according to an embodiment of the present disclosure.

FIG. 7 is a schematic structural diagram of a material placing template according to an embodiment of the present disclosure.

Reference signs in the drawings: 1, driving component, 2, material placing template, 3, push plate, 4, pressing component, 5, pressing bar, 6, auxiliary pressing plate, 7, support, 8, slide bar, 9, long plate, 10, press-applying plate, 11, cam, 12, motor, 13, lever, 14, transmission rod, 15, pressing block, 16, ear plate, 17, aligning rod, 18, bearing, 19, slide rail, 20, long opening, 21, short opening, 22, groove roller, 23, adjusting shaft, 24, tooth hole, 41, upper limit plate, 42, lower limit plate, 43, guide rod, 44, return spring, 45, clamping base, 51, working surface.

### DETAILED DESCRIPTION OF THE EMBODIMENTS

The technical scheme in the embodiments of the present disclosure will be described clearly and completely hereinafter. Obviously, the described embodiments are only some embodiments of the present disclosure, rather than all of the embodiments. Based on the embodiments of the present disclosure, all other embodiments obtained by those skilled in the art without paying creative labor belong to the scope of protection of the present disclosure.

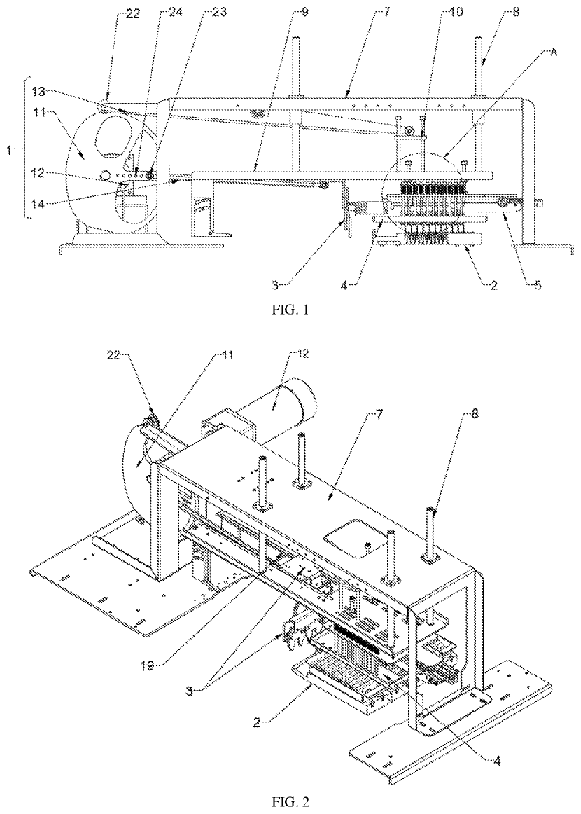

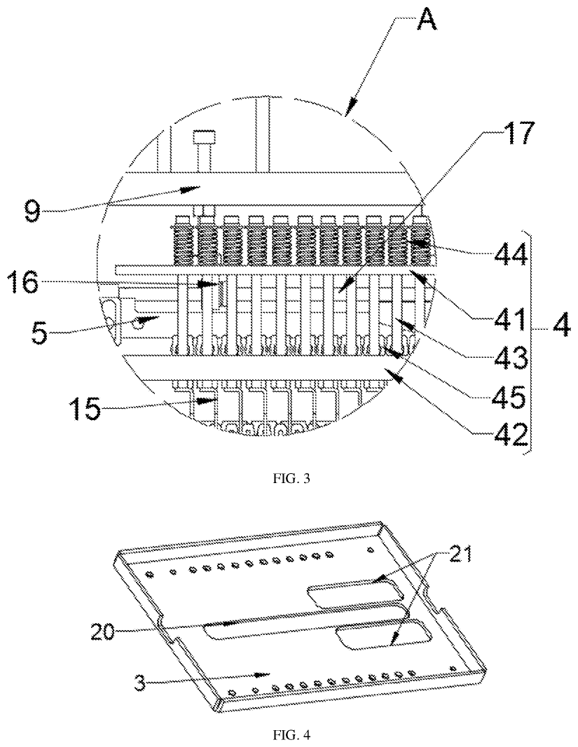

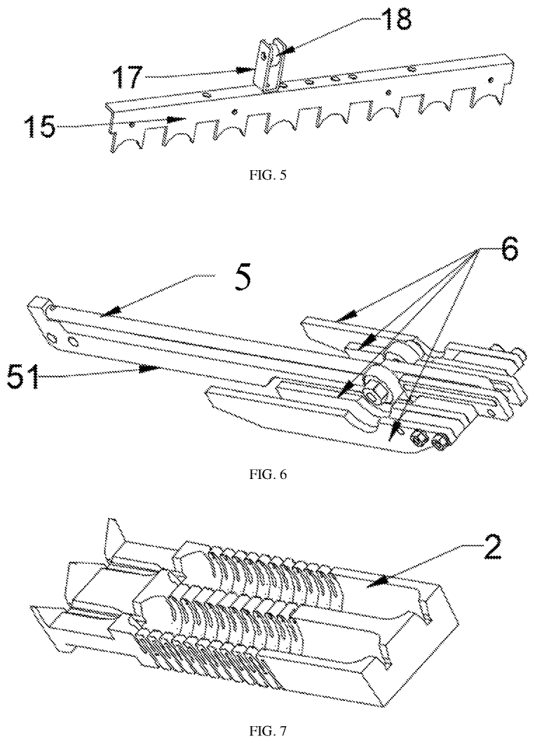

Referring to FIGS. 1-7, in the embodiment of the present disclosure, the device for threading a skewer through an elastic sausage includes a driving component 1, material placing templates 2, a pressing component 4, a push plate 3 and a pressing bar 5. The driving component 1 is connected with the pressing component 4. The pressing component 4 is provided above the material placing templates 2. A plurality of pressing blocks 15 that are transversely and appositionally arranged are provided in the pressing component 4. The pressing bar 5 is provided above the pressing blocks 15. The push plate 3 is provided on a side of the material placing templates 2 and is connected with the driving component 1 and the pressing bar 5.

Specifically, the pressing component 4 includes an upper limit plate 41, a lower limit plate 42 and a plurality of guide rods 43. The pressing blocks 15 are provided below the lower limit plate 42. The guide rods 43 pass through the upper limit plate 41 and the lower limit plate 42 in sequence from top to bottom and are connected with the pressing blocks 15. Return springs 44 are sleeved on the respective guide rods 43. An upper end of the return spring 44 is connected with a top of the guide rod 43. A lower end of the return spring 44 is connected with a top surface of the upper limit plate 41. The pressing bar 5 is provided between the upper limit plate 41 and the lower limit plate 42. One end of the pressing bar 5 is formed with a downward protruding working surface 51. Two sides of an other end of the pressing bar 5 are provided with a plurality of auxiliary pressing plates 6. An ear plate 16 is installed on a bottom surface of the upper limit plate 41. An aligning rod 17 provided along a length direction of the pressing bar is installed on the pressing bar 5. The aligning rod 17 passes through the ear plate 16 and is slidably fitted with the ear plate.

A strip-shaped hole is formed on the auxiliary pressing plate 6. Bolts are provided on the auxiliary pressing plate 6. The bolts pass through the strip-shaped hole and are threadedly fitted with the pressing bar 5. The position of the auxiliary pressing plate 6 can be adjusted according to the actual situation, due to the existence of the strip-shaped hole.

Specifically, the lower limit plate 42 is formed with a long opening 20 and short openings 21. The short openings 21 are provided at two sides of an end of the long opening 20. The long opening 20 and the short openings 21 are each provided with a plurality of clamping bases 45. A top surface of the clamping base 45 is provided with a bearing 18 rotatably fitted with this clamping base. A bottom surface of the clamping base 45 is connected with the pressing block 15. The plurality of clamping bases 45 in the long opening 20 are arranged in manner of a straight line. Ones, which are opposite to the auxiliary pressing plates 6, of the plurality of clamping bases 45 in each short opening 21 are staggered and arranged in sequence. The plurality of clamping bases 45 in each short opening 21 and the auxiliary pressing plates 6 located above are arranged in one-to-one correspondence.

Specifically, the working surface 51 of the pressing bar 5 is rollingly fitted with the bearing 18 of each clamping base 45 in the long opening 20. The plurality of auxiliary pressing plates 6 are arranged appositionally. Inner ones of the auxiliary pressing plates 6 are short, and otter ones of the auxiliary pressing plates 6 are long. Each of the auxiliary pressing plates 6 is rollingly fitted with the bearing 18 of a respective clamping base 45 in a corresponding short opening 21. The working surface 51 of the pressing bar 5 is mutually matched with the bearings 18 of all the clamping bases 45 in the long opening 20. The auxiliary pressing plates 6 are independently matched with the bearings 18 of the clamping bases 45 in each short opening 21.

Specifically, a support 7 and a long plate 9 are provided above the pressing component 4. The long plate 9 is connected with the pressing component 4. A press-applying plate 10 is connected with the long plate 9. The press-applying plate 10 is provided above the long plate 9. Slide rails 19 are formed on the long plate 9. The push plate 3 is installed on the slide rails 19 and is slidably fitted with the slide rails. A plurality of slide bars 8 provided vertically are installed on a top surface of the long plate 9. The slide bars 8 are passed through the support 7 upwards and are slidably fitted with the support.

Specifically, the driving component 1 includes a motor 12, a cam 11, a transmission rod 14 and a lever 13. The motor 12 is installed on the support 7. The cam 11 is installed in front of the long plate 9 and is coaxially connected with a rotating shaft of the motor 12. One end of the transmission rod 14 is hinged with a side surface of the cam 11. An other end of the transmission rod 14 is hinged with the push plate 3. One end of the lever 13 is installed with a groove roller 22 that is rotatably fitted with the lever. An inner wall of a groove of the groove roller 22 is attached to an outer ring of the cam 11. The groove roller 22 is rollingly fitted with the cam 11. The other end of the lever 13 is placed on the press-applying plate 10. A middle section of the lever 13 is installed on the support 7 and is rotatably fitted with the support. A plurality of tooth holes 24 are formed on the side surface of the cam 11. A detachable adjusting shaft 23 is installed in one of the tooth holes 24, and the adjusting shaft 23 is hinged with the transmission rod 14.

The above mentioned adjusting shaft 23 can adjust the position of the adjusting shaft in the tooth holes 24, according to the length of the elastic sausage or the length of the bamboo skewer. The adjusting shaft can also elongate the elastic sausages and thread the bamboo skewers through the respective elastic sausages. The tooth holes 24 are equidistantly arranged.

In the working process, the cam 11 is driven by the motor 12 to rotate. The cam 11 drives the transmission rod 14 and the lever 13 to push the bamboo skewers and press synchronously. When the pressing bar 5 is driven by the transmission rod 14, the rear auxiliary pressing plates 6 press the pressing blocks 15 in the rear short openings 21 firstly, so as to ensure that the elastic sausages are not be squeezed backward or offset due to threading the skewers in the front. The working surface 51 of the pressing bar 5 presses the pressing blocks 15 in the long opening 20 one by one from front to back, and the operation of threading the skewers proceeds synchronously. The pressing blocks 15 are inserted downward among the knots of each elastic sausage, so as to ensure that the elastic sausages are not broken in the process of threading the skewers.

As shown in FIG. 7, the material placing template 2 is formed with slots for placing the respective elastic sausages. Two sides of the material placing template 2 are formed with channels for the bamboo skewer, which are communicated with the respective slots for placing the elastic sausages.

It is obvious to those skilled in the art that the present disclosure is not limited to the details of the above exemplary embodiments, and that the present disclosure can be realized in other specific forms without departing from the spirit or basic characteristics of the present disclosure. Therefore, the embodiments should be regarded as exemplary and non-limiting from any point of view. The scope of the present disclosure is defined by the appended claims rather than the above description, so that it is intended to include all changes falling within the meaning and range of equivalent elements of the claims in the present disclosure.

What is claimed is:

1. A device for threading a skewer through an elastic sausage, the device comprising a driving component, material placing templates, a pressing component, a push plate and a pressing bar, wherein the driving component is connected with the pressing component, the pressing component is provided above the material placing templates, a plurality of pressing blocks which are transversely and appositionally arranged are provided in the pressing component, the pressing bar is provided above the pressing blocks, and the push plate is provided on a side of the material placing templates, and is connected with the driving component and the pressing bar.

2. The device for threading a skewer through an elastic sausage according to claim 1, wherein the pressing component comprises an upper limit plate, a lower limit plate and a plurality of guide rods, the pressing blocks are provided below the lower limit plate, the guide rods pass through the upper limit plate and the lower limit plate in sequence from top to bottom and are connected with the pressing blocks, each of return springs is sleeved on a corresponding one of the guide rods, an upper end of the return spring is connected with a top of the corresponding one of the guide rods, and a lower end of the return spring is connected with a top surface of the upper limit plate.

3. The device for threading a skewer through an elastic sausage according to claim 2, wherein the pressing bar is provided between the upper limit plate and the lower limit plate, one end of the pressing bar is formed with a downward protruding working surface, two sides of an other end of the pressing bar are provided with a plurality of auxiliary pressing plates, an ear plate is installed on a bottom surface of the upper limit plate, an aligning rod provided along a length direction of the pressing bar is installed on the pressing bar, and the aligning rod is passed through the ear plate and is slidably fitted with the ear plate.

4. The device for threading a skewer through an elastic sausage according to claim 2, wherein the lower limit plate is formed with a long opening and short openings; the short openings are provided at two sides of an end of the long opening, the long opening and the short openings are each provided with a plurality of clamping bases; a top surface of each of the plurality of clamping bases is provided with a bearing rotatably fitted with the clamping base; and a bottom surface of each of the clamping bases is connected with a corresponding one of the pressing blocks.

5. The device for threading a skewer through an elastic sausage according to claim 4, wherein the plurality of clamping bases in the long opening are arranged in manner of a straight line, and the plurality of clamping bases in each of the short openings are obliquely arranged.

6. The device for threading a skewer through an elastic sausage according to claim 4, wherein the working surface of the pressing bar is rollingly fitted with the bearing of each of the clamping bases in the long opening, the plurality of auxiliary pressing plates are arranged appositionally, inner ones of the auxiliary pressing plates are short, outer ones of the auxiliary pressing plates are long, ones, which are opposite to the auxiliary pressing plates, of the plurality of clamping bases in each of the short openings are staggered and arranged in sequence, and each of the auxiliary pressing plates is rollingly fitted with the bearing of a respective one of the plurality of clamping bases in a corresponding one of the short openings.

7. The device for threading a skewer through an elastic sausage according to claim 5, wherein the working surface of the pressing bar is rollingly fitted with the bearing of each of the clamping bases in the long opening, the plurality of auxiliary pressing plates are arranged appositionally, inner ones of the auxiliary pressing plates are short, outer ones of the auxiliary pressing plates are long, ones, which are opposite to the auxiliary pressing plates, of the plurality of clamping bases in each of the short openings are staggered and arranged in sequence, and each of the auxiliary pressing plates is rollingly fitted with the bearing of a respective one of the plurality of clamping bases in a corresponding one of the short openings.

8. The device for threading a skewer through an elastic sausage according to claim 6, wherein the working surface of the pressing bar is mutually matched with the bearing of each of the plurality of the clamping bases in the long opening, and the auxiliary pressing plates are independently matched with the bearing of each of the plurality of clamping bases in each of the short openings.

9. The device for threading a skewer through an elastic sausage according to claim 7, wherein the working surface of the pressing bar is mutually matched with the bearing of each of the plurality of the clamping bases in the long opening, and the auxiliary pressing plates are independently matched with the bearing of each of the plurality of clamping bases in each of the short openings.

10. The device for threading a skewer through an elastic sausage according to claim 1, wherein a support and a long plate are provided above the pressing component, the long plate is connected with the pressing component, a press-applying plate is connected with the long plate, the press-applying plate is provided above the long plate, slide rails are formed on the long plate, the push plate is installed on the slide rails and is slidably fitted with the slide rails, a plurality of slide bars provided vertically are installed on a top surface of the long plate, and the slide bars are passed through the support upwards and are slidably fitted with the support.

11. The device for threading a skewer through an elastic sausage according to claim 10, wherein the driving component comprises a motor, a cam, a transmission rod and a lever, the motor is installed on the support, the cam is installed in front of the long plate and is coaxially connected with a rotating shaft of the motor, one end of the transmission rod is hinged with a side surface of the cam, an other end of the transmission rod is hinged with the push plate, one end of the lever is installed with a groove roller that is rotatably fitted with the lever, an inner wall of a groove of the groove roller is attached to an outer ring of the cam, the groove roller is rollingly fitted with the cam, an other end of the lever is placed on the press-applying plate, and a middle section of the lever is installed on the support and is rotatably fitted with the support.

12. The device for threading a skewer through an elastic sausage according to claim 11, wherein a plurality of tooth holes are formed on the side surface of the cam, a detachable adjusting shaft is installed in one of the tooth holes, and the adjusting shaft is hinged with the transmission rod.
